(19) United States
(12) Patent Application Publication
(10) Pub. No.: US 2013/0232780 A1
(43) Pub. Date: Sep. 12, 2013

(54) FOUNDATION FOR SUPPORTING A POLE

(71) Applicant: Malcolm Kurt PENFOLD, Elmira (CA)

(72) Inventor: Malcolm Kurt PENFOLD, Elmira (CA)

(73) Assignee: TRYLON TSF INC., Elmira (CA)

(21) Appl. No.: 13/412,749

(22) Filed: Mar. 6, 2012

(51) Int. Cl. H01R 43/00; E04G 21/00; E02D 27/42

(52) U.S. Cl. 29/825; 52/297; 52/741.14

(57) ABSTRACT

A foundation for supporting a pole is disposed at least in part in a hole in a ground where the pole is to be installed. The foundation has a casing defining an internal cavity and has an exterior surface; a substance including at least concrete is disposed inside the cavity and inside a gap defined between the exterior surface of the casing and an interior surface of the hole; and a pole connector connected to an upper portion of the casing for connecting the pole to the foundation.

### FIELD OF THE INVENTION

The present invention relates to a foundation for supporting a pole.

### BACKGROUND

Outdoor poles are often used to support antennas, lights, cameras, cables or other similar components. It can be costly and time-consuming to erect and replace such poles and there is often pressure to construct foundations and poles within a two day period in order to minimize construction time activity while also yielding a vertical pole that will remain vertical over many years. Outdoor poles are intended to remain secure and stable in the soil for many years. However, various forces, primarily wind, and other weather related factors such as frost create a load bearing on the pole and foundation that could cause the pole to become unstable or “tilted” (non vertical) in the soil. To prevent this, outdoor poles require a structurally adequate and lasting foundation. Commonly, foundations for outdoor poles are either constructed with a direct imbedment section into soil or constructed using concrete or high early strength concrete with rebar placed in the concrete for resilience and strength. Constructing direct imbedment foundation usually results in a tilted pole (or tilted over time pole) and does not facilitate correction of the verticality. Constructing a reinforced concrete foundation is costly and time consuming.

Further, installing a conventional rebar reinforced concrete outdoor pole foundation requires multiple steps that take a number of days or weeks to complete. It generally takes about a week to two weeks in order to prepare and install a conventional foundation in the soil and to secure a pole to it.

Therefore, there is a need for a foundation for supporting a pole that is quick to construct, cure, that can withstand the various forces experienced by a pole installed outdoors, that conforms to the National Design and Construction Standards, including Canadian standard CSA S27-01 (“Antennas, Towers and Antenna Supporting Towers”) and United States standard TIA-222-G (“Structural Standards for Steel, Antennas, Towers, and Antenna Supporting Structures”) and facilitates installation of a pole that remains vertical.

### SUMMARY

According to one aspect, provided is a foundation for supporting a pole, the foundation being disposed at least in part in a hole in a soil where the pole is to be installed, the foundation comprising: a casing defining an internal cavity and having an exterior surface; a substance including at least concrete disposed inside the cavity and inside a gap defined between the exterior surface of the casing and an interior surface of the hole; and a pole connector connected to an upper portion of the casing for connecting the pole to the foundation.

According to another aspect, the substance fills the internal cavity and the gap.

According to another aspect, the casing defines an aperture at an upper end thereof for receiving the substance, and wherein the pole connector is disposed in the aperture.

According to another aspect, the casing defines at least one aperture fluidly communicating the internal cavity with the gap for allowing the substance to flow from the internal cavity to the gap.

According to another aspect, at least one conduit has a first portion disposed in the internal cavity of the casing and a second portion passing through one of the at least one apertures defined by the casing and extending externally of the casing.

According to another aspect, at least one wire passes through one of the at least one conduit for connecting one of a power source external to the casing to an electrical component secured to the pole, and an antenna system attached to the pole to a receiver external to the pole.

According to another aspect, the pole connector comprises a plurality of nut and bolt attachments; and wherein the nut and bolt attachments provide an adjustable connection for the pole such that an angle of the pole relative to vertical can be altered by adjusting at least one of the nut and bolt attachments.

According to another aspect, the substance is high early strength concrete.

According to another aspect, the pole connector comprises a plate defining an aperture.

According to another aspect, provided is a pole and foundation assembly comprising: a foundation assembly having a foundation as defined above; and a pole connected to the pole connector.

According to another aspect, provided is a method for installing a pole and foundation assembly. The method comprises: forming a hole in the ground sized to receive a casing in a spaced relationship to define a gap between an exterior surface of the casing and an interior surface of the hole; placing the casing in the hole in the spaced relationship, the casing defining an internal cavity; pouring a substance into an open end of the casing such that the substance fills at least a majority of the internal cavity, the substance including at least concrete; filling at least a majority of the gap with the substance; waiting for the substance to harden; and after the substance has hardened, securing a pole to a pole connector connected to an upper portion of the casing.

According to another aspect, filling at least a majority of the gap with the substance comprises filling at least the majority of the gap with the substance flowing from the internal cavity to the gap via at least one aperture defined in the casing and fluidly communicating the internal cavity with the gap.

According to another aspect, prior to pouring the substance, at least one conduit extending through one of the at least one aperture is provided such that a first portion of the conduit is disposed in the internal cavity of the casing and a second portion of the conduit extends externally of the casing.

According to another aspect, at least one wire passes through the pole and the at least one conduit for connecting one of a power source external to the pole to an electrical component secured to the pole and an antenna system attached to the pole to a receiver external to the pole for transmitting electrical data between the antenna and the receiver.

According to another aspect, the pole connector is adjusted to adjust an angle of the pole relative to vertical.

According to another aspect, the pole connector comprises a plurality of nut and bolt attachments; and the step of adjusting comprises adjusting at least one of the nut and bolt attachments.

Embodiments of the present invention each have at least one of the above-mentioned aspects, but do not necessarily have all of them. It should be understood that some aspects of the present invention that have resulted from attempting to solve one or more of the above mentioned problems may satisfy other problems not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, in which:

FIG. 1 is a partially cut away side elevation view of an installed pole and foundation assembly;

FIG. 2 is a perspective view of a portion of a casing and of a conduit of the pole and foundation assembly of FIG. 1;

FIG. 3 is a partial cross-sectional view of the casing of the pole and foundation assembly of FIG. 1 in the soil;

FIG. 4 is a partial cross-sectional view of the casing of the pole and foundation assembly of FIG. 1 in the soil partially filled with concrete;

FIG. 5 is a close-up view of a pole connector of the pole and foundation assembly of FIG. 1;

FIG. 6 is a side elevation view of a portion of the pole and foundation assembly of FIG. 1; and

FIG. 7 is a flowchart depicting a method for supporting a pole.

### DETAILED DESCRIPTION

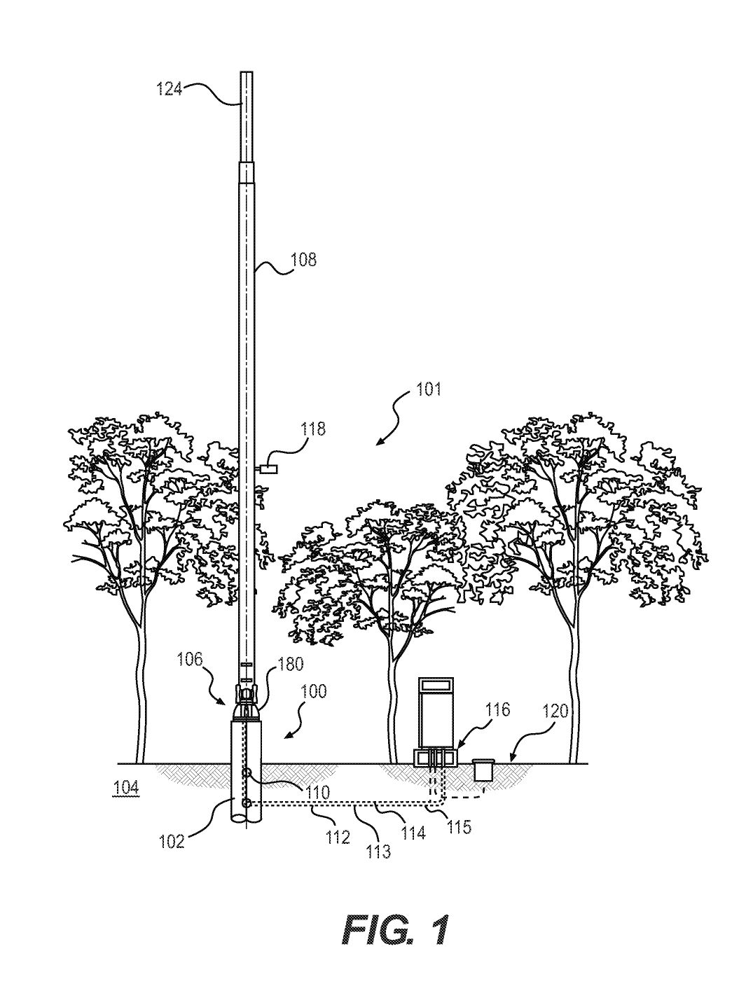

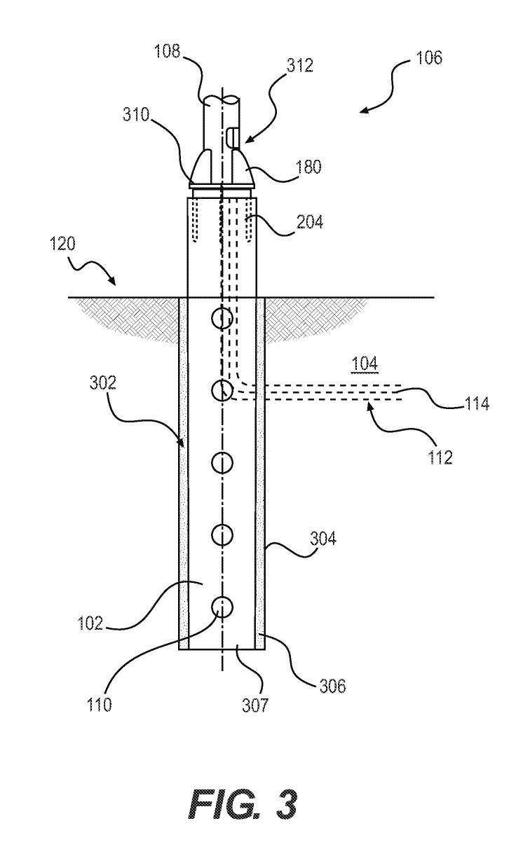

FIG. 1 shows a foundation 100 supporting a pole 108 that together form a pole and foundation assembly 101. The foundation 100 is disposed in part in the soil 104 below a top surface 120 thereof. The foundation 100 includes a casing 102 having multiple apertures 110, concrete (described below with reference to FIG. 3) and a pole connector 106. The apertures 110 are formed in a side of the casing 102. A conduit (or conduits) 112 (shown in dotted lines in FIG. 1) passes through one of the apertures 110. A wire (or cables) 114 is disposed inside the conduit 112. A power source 116 is external of the casing 102 and is electrically connected to one end of the wire 114. A street light 118 is attached to the pole 108 and is electrically connected to another end of the wire 114. It is contemplated that other kinds of electrical or video components, such as a camera, could be attached to the pole 108. An antenna system 124 is attached to the top of the pole 108. In other embodiments, there is no antenna system 124 attached to the pole 108. In other embodiments, there is no electrical component attached to the pole 108.

The power source 116 provides electricity to the street light 118 through the wire (cable) 114. The wire (cable) 114 passes through the casing 102 and through an interior passage in the pole 108 to connect to the street light 118. A second conduit 113 passes through one of the apertures 110 with a second wire (cable) 115 passing through it. A receiver is external of the casing 102. The second conduit 113 passes underground from the casing 102 to the receiver so that the second wire (cable) 115 passing through the second conduit 113 connects to the receiver. The second wire (cable) 115 extends from the receiver through the second conduit 113, through the casing 102 to the pole 108. The second wire (cable) 115 passes from the casing 102 and extends internally of the pole to the antenna system 124. The second wire (cable) 115 transmits signals from the antenna 124 to the receiver and vice versa. It is contemplated that the second wire (cable) 115 can travel from the casing 102 externally of the pole 108 to the antenna 124. It is recognized that the two wires (cables) 114, 115 can pass through the same conduit 212. In further embodiments there can be more than two wires (cables) 114 passing through one or more conduits 212 in the casing 102. The antenna system 124 can be a cellular radio antenna, for example.

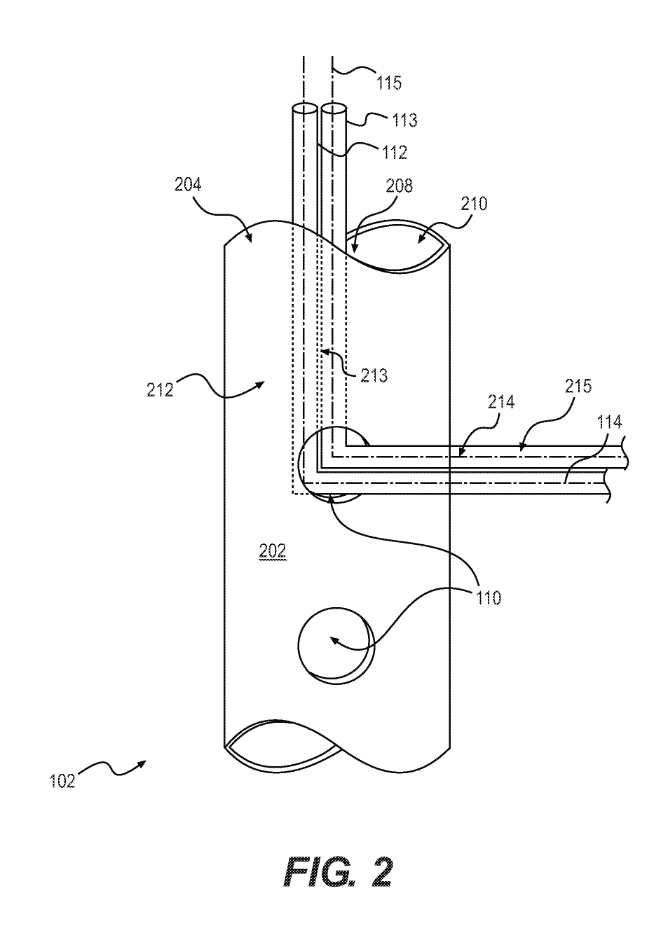

Referring to FIG. 2, the casing 102 defines an internal cavity 208 and has an exterior surface 202. The casing 102 is cylindrical. In alternative embodiments, the casing 102 can have different shapes including, but not limited to, rectangular or multi-sided. The casing 102 has a plurality of apertures 110 through its external surface 202 leading to the internal cavity 208. For example, the casing 102 can have fifteen apertures 110 with three sets of five apertures 110 equally separated and vertically and equally disposed along the casing 102. Two such apertures 110 are shown in FIG. 2. In yet further alternative embodiments, the casing 102 has one aperture 110. The casing 102 is made of galvanized steel and serves as the structural foundation portion to support the pole 108 above. It is contemplated that the casing 102 could be made of other materials such as stainless steel or fibre reinforced structural material.

The casing 102 has an upper end 204 and a lower end 307 (see FIG. 3). The upper end 204 of the casing 102 defines an aperture 210. The aperture 210 leads to the internal cavity 208 of the casing 102. The apertures 110 fluidly connect the internal cavity 208 of the casing 102 with the exterior of the casing 102.

Still referring to FIG. 2, the conduit 112 has a first portion 212 and a second portion 214. The first portion 212 of the conduit 112 is disposed in the internal cavity 208 of the casing 102. The second portion 214 of the conduit 112 passes from the internal cavity 208 of the casing 102 through one of the apertures 110 in the casing 102 and extends externally of the casing 102. The wire 114 (shown in dotted lines where obstructed from view) passes through the inside of the conduit 112. Similarly, the second conduit 113 has a first portion 213 and a second portion 215 with the first portion 213 disposed in the internal cavity 208 of the casing 102 and the second portion 215 passing from the internal cavity 208 through one of the apertures 110 and extending externally of the casing 102. The second wire 115 passes through the inside of the second conduit 113. The conduits 112, 113 can be of different lengths and/or diameters. For example, the conduit 112 can extend from the power source 116 to the pole connector 106. By way of further example, the second conduit 113 can extend from the receiver to the pole connector 106. In another example, the conduit 112 can extend from the power source 116 through the soil 104, the aperture 110, the internal cavity 208 of the casing 102 and an interior passage in the pole 108 to the street light 118.

FIG. 3 shows the casing 102 disposed in part in a hole 302 in the soil 104. The casing 102 is substantially vertical. The hole 302 has an interior surface 304 facing the casing 102. A gap 306 is defined between the exterior surface 202 of the casing 102 and the interior surface 304 of the hole 302. Each aperture 110 in the casing 102 fluidly communicates the internal cavity 208 with the gap 304. Concrete 308 is disposed inside the internal cavity 208 and inside the gap 304 and completely fills the internal cavity 308 and the gap 304. It is contemplated that other substances having at least some concrete could be used, such as high early strength concrete. For example, it is contemplated that for some applications only high early strength concrete could be used. In this figure, the second conduit 113 (not visible) is behind the first conduit 112.

In the embodiment shown in FIG. 3, the pole connector 106 is connected to the upper end 204 the casing 102. In alternative embodiments, the pole connector 106 can be attached to the side of the casing 112. By way of further example, the pole connector 106 can be connected to an upper portion of the casing 112 other than the upper end 204. The pole connector 106 connects the pole 108 to the casing 102 such that the pole 108 is supported in an upright (i.e. vertical) position (see FIG. 1 for example).

More specifically, the pole connector 106 connects the upper end 204 of the casing 102 to a bottom end 312 of the pole 108. When the pole 108 is connected to the casing 102 using the pole connector 106, the pole 108 stands upright and is supported by foundation 100.

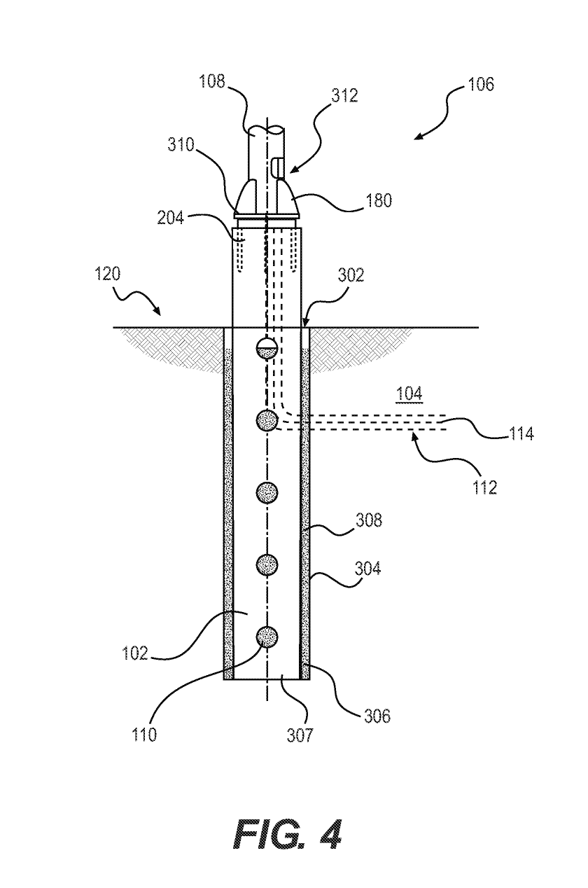

According to an alternative embodiment, the gap 304 and the internal cavity 208 are only partially filled with concrete 308. For example, FIG. 4 shows the casing 102 disposed in part in a hole 302 in the soil 104 with the majority of the volume of the gap 304 and the internal cavity 208 filled with concrete 308. In one embodiment, the concrete 308 requires a relatively low twenty-eight day strength of 15 to 20 MPa given that its function is to provide incompressible fill material around and up through the casing and be impervious to water and contains an air entraining agent. In another embodiment, the substance is quick setting high early strength concrete 308 in order to facilitate “next day” installation of the pole 108 to be attached to the top of the casing 102.

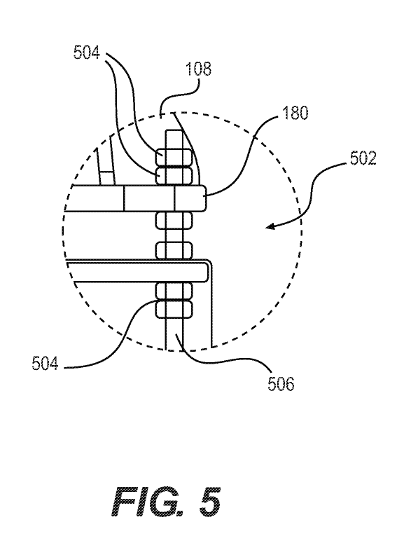

FIG. 5 is a close-up view of an embodiment of the pole connector 106. The pole connector 106 comprises a number of nut and bolt attachments 502, which themselves comprise nuts 504 and bolts 506. The nut and bolt attachments 502 attach the pole 108 to the casing 102 such that the angle of the pole 108 relative to the soil can be altered by adjusting one or more of the nut and bolt attachments 502. For example, the nuts 504 that secure the pole 108 to the bolt 506 can be adjusted in order to adjust the positioning of the pole 108 on the bolt 506. This results in a corresponding adjustment in the angle of the pole 108 relative to the casing 102.

The pole connector 106 further comprises a plate at the top end 204 of the casing 102. The plate has a central aperture and a number of smaller apertures around the exterior of the central aperture. The smaller apertures receive the bolts 506 so that when the plate is on the top end 204 of the casing 102 one end of the bolt 506 extends into the internal cavity 208 and the other end of the bolt 506 extends upward to attach to the pole 108. When the internal cavity 108 filled with concrete 308 the bolt 506 is partially immersed in the concrete 308. When the concrete 308 hardens the bolts 506 become secured in the concrete and thus secured to the pole 108. The bottom end 312 of the pole 108 has a flange 180 that is connected to the pole 108. The flange 180 has apertures that receive the bolt 506 so as to fasten the pole 108 to the casing 102.

It is recognized that there can be other types of pole connectors 106 for connecting the pole 108 to the casing 102. For example, the pole connector 106 can be a flat plate defining an aperture. The pole 108 can be secured within the aperture of the plate with the plate attached to the casing 102 such that the pole 108 aligns with the casing 102. The pole connector 106 can be integral with the casing 102 or with the pole 108. By way of further example, the pole connector 106 can be disposed in the aperture 210 at the upper end 204 of the casing 102. Different types of poles 108 can be attached to the casing 102 using the pole connector 106.

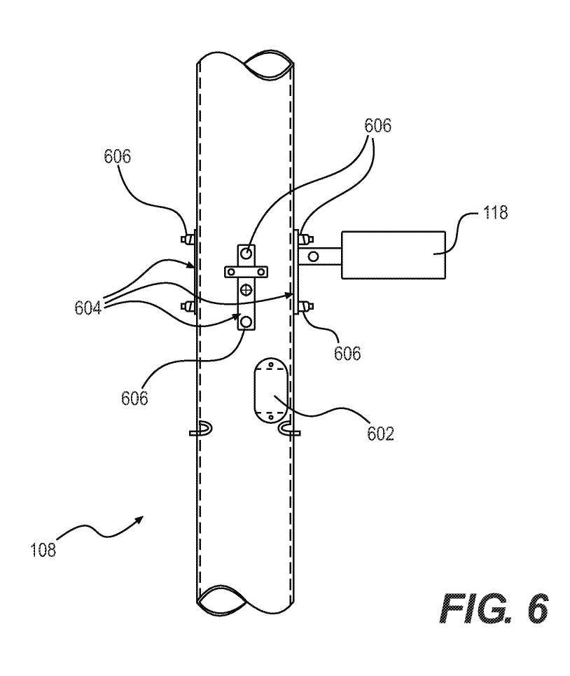

FIG. 6 shows a section of the pole 108. The pole 108 includes an access cover 602, brackets 604 and nut and bolt 606. The street light 118 is attached to the pole 108 by the nuts and bolts 606 of one of the brackets 604. There can be additional brackets 604 on the pole 108 at different heights depending on the desired placement of the street light 118 or other electrical component. More than one electrical component can be supported by the pole 108.

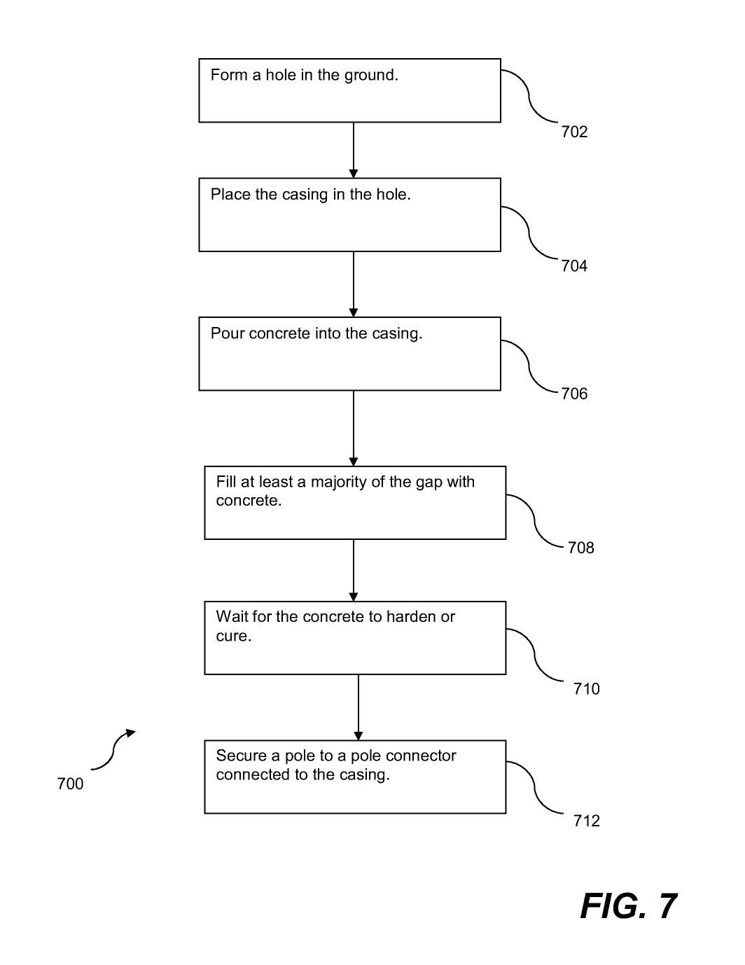

FIG. 7 is a flow chart showing a method 700 for installing a pole and foundation assembly 101 of the type described above.

At step 702 a hole 302 is formed in the soil 104. The hole 302 can be manually dug into the soil or formed by a machine such as an auger. The hole 302 is sized to receive the casing 102 in a spaced relationship to define a gap 306 between the exterior surface 202 of the casing 102 and the interior surface 304 of the hole 302. The hole 302 is complimentary in shape to the casing 102 so that the casing 102 can fit into the hole with a substantially uniform space (or gap 304) surrounding the casing 102 between the interior surface 302 of the hole and the exterior surface 202 of the casing 102. It is contemplated that the shape of the hole 302 could differ from the shape of the casing 102.

At step 704 the casing 102 is placed in the hole 302 in the spaced relationship. The casing 102 is placed vertically in the hole 302 so that the open top end 210 is accessible from above the ground 104. It is contemplated that the top of the casing 102 can be flush with the surface of the ground 104 or slightly above in order to protect the pole base from accumulating water or ice.

At step 706, the concrete 308 is placed (or poured) into the open end 210 of the casing 102 such that the concrete 308 fills at least a majority of the internal cavity 208 of the casing 102. Before the concrete 308 is placed into the casing 102, the casing 102 can be straightened so that it is substantially vertical.

As the concrete 308 is placed into the casing 102, it flows from the internal cavity 208 into the gap 304 via the apertures 110. In this way the concrete 308 that is placed into the internal cavity 208 of the casing 102 fills both the internal cavity 208 and the gap 304 at the same time (step 708). The concrete 308 is placed into the open end 210 such that it fills all of the voids in the gap 304. In an alternative embodiment, the substance 308 is placed directly into the gap 304 and directly into the internal cavity 208. The concrete 108 is placed such that it completely fills the gap 304 and the internal cavity 208 thus preventing moisture from entering into the internal cavity 208 of the casing 102.

The next step, shown at 710, is to wait for the concrete 308 to harden sufficiently. This can take twelve hours or more. When the concrete 308 hardens, the casing 102 is secured in the hole in the ground 104 thereby forming a foundation for the pole 108.

At step 712, the pole 108 is secured to the pole connector 106. During this step 712, prior to securing the pole 108 to the pole connector 106, the wires and cables 114, 115 extending from the internal cavity 208 through the open end 210 are connected to the street light 118 (or other electrical component) and the antenna 124 respectively.

The method 700 of installing a pole and foundation assembly 101 explained above takes about two days to complete. Steps 702 to 708 are done on one day. The concrete hardens overnight (step 710). On the following day the pole 108 is secured to the casing 102 (step 712).

The determination of the length, diameter and thickness of the casing 102 that should be used, the size of the hole and the amount and type of concrete 308 to use is dependent on the size of the pole 108 and the load applied to the pole 108 (e.g. the weather, the number and type of components attached to the pole 108 and whether an antenna 124 is attached to the pole 108). Further, the type of soil in the ground is also a consideration when selecting the properties of the foundation and pole assembly 101.

It is understood that the concrete 308 fills the internal cavity 208 and the gap 304 and serves only as an incompressible fill material that is impervious to water. The insertion galvanized steel section (i.e. the casing 102) serves as the structural foundation and facilitates conduits that may be required to enter below grade and exit up thru the surface of the interior (to facilitate flexible electrical and/or transmission lines required to be installed inside the pole section above grade). The casing 102 defining the internal cavity 208 represents the primary structural component of the foundation design.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A foundation for supporting a pole, the foundation being disposed at least in part in a hole in a soil where the pole is to be installed, the foundation comprising:
a casing defining an internal cavity and having an exterior surface;
a substance including at least concrete disposed inside the cavity and inside a gap defined between the exterior surface of the casing and an interior surface of the hole; and
a pole connector connected to an upper portion of the casing for connecting the pole to the foundation.

2. The foundation of claim 1, wherein the substance fills the internal cavity and the gap.

3. The foundation of claim 1, wherein the casing defines an aperture at an upper end thereof for receiving the substance, and wherein the pole connector is disposed in the aperture.

4. The foundation of claim 1, the casing defining at least one aperture fluidly communicating the internal cavity with the gap for allowing the substance to flow from the internal cavity to the gap.

5. The foundation of claim 4, further comprising at least one conduit having a first portion disposed in the internal cavity of the casing and a second portion passing through one of the at least one apertures defined by the casing and extending externally of the casing.

6. The foundation of claim 5, further comprising at least one wire passing through one of the at least one conduit for connecting one of a power source external to the casing to an electrical component secured to the pole, and an antenna system attached to the pole to a receiver external to the pole.

7. The foundation of claim 1, wherein the pole connector comprises a plurality of nut and bolt attachments; and
wherein the nut and bolt attachments provide an adjustable connection for the pole such that an angle of the pole relative to vertical can be altered by adjusting at least one of the nut and bolt attachments.

8. The foundation of claim 1, wherein the substance is high early strength concrete.

9. The foundation of claim 1, wherein the pole connector comprises a plate defining an aperture.

10. A pole and foundation assembly comprising:
a foundation as defined in claim 1; and
a pole connected to the pole connector.

11. The pole and foundation assembly of claim 10, wherein the substance fills the internal cavity and the gap.

12. The pole and foundation assembly of claim 10, wherein the casing defines an aperture at an upper end thereof for receiving the substance, and wherein the pole connector is disposed in the aperture.

13. The pole and foundation assembly of claim 10, the casing defining at least one aperture fluidly communicating the internal cavity with the gap for allowing the substance to flow from the internal cavity to the gap.

14. The pole and foundation assembly of claim 13, further comprising at least one conduit having a first portion disposed in the internal cavity of the casing and a second portion passing through one of the at least one apertures defined by the casing and extending externally of the casing.

15. The pole and foundation assembly of claim 14, further comprising a wire passing through the pole and one of the at least one conduit for connecting one of a power source external to the casing to an electrical component secured to the pole, and an antenna system attached to the pole to a receiver external to the pole.

16. The pole and foundation assembly of claim 10, wherein the pole connector comprises a plurality of nut and bolt attachments, and wherein the nut and bolt attachments provide an adjustable connection for the pole such that an angle of the utility pole relative to vertical can be altered by adjusting at least one of the nut and bolt attachments.

17. The pole and foundation assembly of claim 10, wherein the substance is high early strength concrete.

18. The pole and foundation assembly of claim 10, wherein the pole connector comprises a plate defining an aperture.

19. A method for installing a pole and foundation assembly comprising:
forming a hole in the ground sized to receive a casing in a spaced relationship to define a gap between an exterior surface of the casing and an interior surface of the hole;
placing the casing in the hole in the spaced relationship, the casing defining an internal cavity;
pouring a substance into an open end of the casing such that the substance fills at least a majority of the internal cavity, the substance including at least concrete;
filling at least a majority of the gap with the substance;
waiting for the substance to harden; and
after the substance has hardened, securing a pole to a pole connector connected to an upper portion of the casing.

20. The method of claim 19, wherein filling at least a majority of the gap with the substance comprises filling at least the majority of the gap with the substance flowing from the internal cavity to the gap via at least one aperture defined in the casing and fluidly communicating the internal cavity with the gap.

21. The method of claim 20, further comprising, prior to pouring the substance, providing at least one conduit extending through one of the at least one aperture such that a first portion of the conduit is disposed in the internal cavity of the casing and a second portion of the conduit extends externally of the casing.

22. The method of claim 21, further comprising:
passing at least one wire through the pole and the at least one conduit for connecting one of a power source external to the pole to an electrical component secured to the pole and an antenna system attached to the pole to a receiver external to the pole for transmitting electrical data between the antenna and the receiver.

23. The method of claim 19, further comprising adjusting the pole connector to adjust an angle of the pole relative to vertical.

24. The method of claim 23, wherein the pole connector comprises a plurality of nut and bolt attachments; and
wherein the step of adjusting comprises adjusting at least one of the nut and bolt attachments.
